(19) United States
(12) Patent Application Publication
(10) Pub. No.: US 2015/0193243 A1
(43) Pub. Date: Jul. 9, 2015

(54) SYSTEM AND METHOD FOR EXTRACTING DATA FROM LEGACY DATA SYSTEMS TO BIG DATA PLATFORMS

(71) Applicant: Veristorm, Inc., Santa Clara, CA (US)

(72) Inventors: Anil VARKHEDI, San Jose, CA (US); Venkatesh Thati, San Jose, CA (US); Atul Nanda, Cupertino, CA (US); Michael Alper, San Jose, CA (US)

(73) Assignee: Veristorm, Inc., Santa Clara, CA (US)

(21) Appl. No.: 14/147,843

(22) Filed: Jan. 6, 2014

(51) Int. Cl. G06F 9/455; G06F 3/0484

(52) U.S. Cl. CPC G06F 9/45533; G06F 3/04842

(57) ABSTRACT

A system and method for extracting data from legacy data management systems and making the data available to Big Data platforms with minimal use of compute and intermediate storage resources.

### TECHNICAL FIELD

This disclosure relates generally to the field of data processing, and more particularly, to systems and methods for selecting and extracting data from a legacy data management system on a mainframe computer system, and transferring the data into a platform configured for processing Big Data in the same or a separate logical partition on the mainframe computer system.

### BACKGROUND

The exponential growth and availability of data, both structured and unstructured, has presented challenges to organizations with responsibilities for managing the data. For many companies, the voluminous data of the company is stored in one or more legacy data management systems on or accessible by a mainframe computer, and operations and/or analysis of the data typically requires utilizing the resources of the mainframe computer. It is now common to refer to any commercial-use computer, large or small, as a server, and use of the term “mainframe computer” has come to mean simply the largest type of available server in use, capable of supporting large numbers of applications and input/output devices to simultaneously serve a large numbers of users.

In one example, the availability of additional data has created large datasets (commonly known as “Big Data”) that permit more complex and comprehensive analysis of the data, but such operations likewise require more processing capability, which may unduly tax the resources of the mainframe computer. For example, performing analytics of business data on the mainframe typically results in higher processing costs. Further, taking data out of the mainframe for analytics may compromise data security. The problem is magnified by the acute shortage of skills and the cost of skilled programmers working with legacy mainframe data. Thus, it would be desirable to have improved methods for analyzing data that is stored in legacy mainframe systems.

### BRIEF DESCRIPTION OF THE DRAWINGS

FIG. 1 is schematic block diagram of a mainframe computing system having two logical partitions, with multiple virtual machine instances installed in one of the partitions to support a Big Data platform.

FIG. 2 is a flow chart illustrating a process for selecting data from a legacy data management source in one partition, transferring and converting data to a Big Data platform in the same or other partition.

FIG. 3 is flow diagram illustrating the flow of data during a data transfer process.

FIGS. 4A-4G are a series of screenshots illustrating a graphical user interface for performing the process of FIG. 2.

### DETAILED DESCRIPTION

This disclosure describes a system and method for extracting data from legacy data management systems and making the data available to Big Data platforms with minimal use of compute and intermediate storage resources.

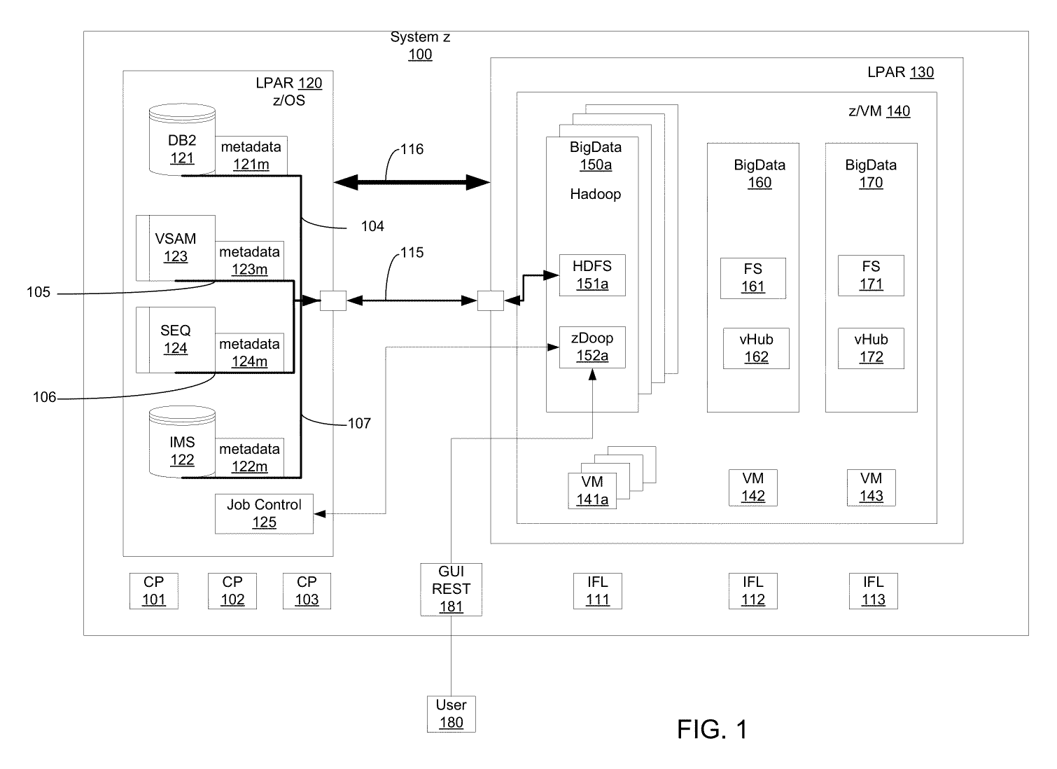

FIG. 1 illustrates a mainframe computer 100 having a mainframe operating system deployed within a first logical partition LPAR 120. For example, the platform 100 may be an IBM System z mainframe computer configured with operating system z/OS and supporting system operations through a number of central processor engines, such as CP 101, CP 102 and CP 103, as is well-known.

The first partition LPAR 120 also contains or is configured to access legacy data management systems. For example, structured data may be stored and accessed in a relational database system DB2 121, or a hierarchical database system, such as IBM's Information Management System (“IMS”) 122. Likewise, unstructured data may be stored and accessed using a Virtual Storage Access Method (“VSAM”) 123, or a Sequential Access Method (“SEQ”) 124.

All data stored in the data management systems 121-124 has metadata associated with it. Thus, to generalize, selected data in management system DB2 121 has metadata 121m; selected data in management system IMS 122 has metadata 122m; selected data in management system VSAM 123 has metadata 123m; and selected data in management system SEQ 124 has metadata 124m. Each data management system also has an interface configured to communicate with a second logical partition 130, described below, to pass data, metadata and control information.

The first partition LPAR 120 also includes a job control module 125 that creates or is provided with instructions on how to run a batch job or start a subsystem. For example, IBM's Job Control Language (“JCL”) may be used to create suitable instructions in well known manner for System z implementations, or other languages may be used with other implementations.

The second logical partition LPAR 130 is configured with a virtual operating system 140 to operate and manage multiple virtual machines to support multiple instances of application platforms and/or operating sub-systems. For example, the virtual operating system 140 may be an IBM hypervisor program, indicated as z/VM, which deploys as a virtual machine monitor for operating and managing multiple virtual machine instances, such as nodes VM 141a, VM 142a, VM 143a, etc. Although the IBM hypervisor is common for managing virtual machine instances, other systems and platforms could also be used without loss of generality. In one embodiment, the mainframe operating system could be deployed as a virtual machine instance monitored by the virtual operating system (z/VM).

In an embodiment, the virtual machine nodes are configured to support a cluster of data processing applications thereby providing a large parallel processing capability. For example, virtual machine nodes 141a-141n are configured to support a cluster of multiple Big Data application instances 150a-150n. Additional clusters could be formed within the same partition. For example, virtual machine nodes 142a-142n can be configured to support a cluster of Big Data applications 160a-160n; and virtual machine nodes 143a-143n can be configured to support a cluster of Big Data applications 170a-170n. Examples of Big Data applications include Hadoop, Cassandra and MongoDB. In this disclosure, Big Data applications 150a-150n are described as Hadoop instances.

Each cluster of virtual machine instances forms a Big Data platform that is integrated with the mainframe system 100 through a dedicated processor. For example, the virtual machine nodes VM 141a-141n are integrated through dedicated processor IFL 111; virtual machine nodes VM 142a-142n are integrated through dedicated processor IFL 112; and virtual machine nodes VM 143a-143n are integrated through dedicated processor IFL 113. In a System z embodiment, each virtual machine may be implemented as a Linux instance or equivalent, and the corresponding dedicated processors may be implemented using IBM's Integrated Facility for Linux (“IFL”) or equivalent as the dedicated processors.

Each of the Big Data application instances includes a native file system and a virtual machine. Thus, Big Data application 150a includes a file system 151 and a virtual machine 152a; Big Data application 160a includes a file system 161 and a virtual machine 162; and Big Data application 170a includes a file system 171 and a virtual machine 172. For example, in a Hadoop embodiment as Big Data application 150a, the file system 151 is the Hadoop Distributed File System (“HDFS”).

A software program running on a virtual machine, also called a vHub interface herein, is configured on each Big Data platform to include programmed instructions that: (i) create jobs to run on the job control module 125 to extract identified data and metadata and return it to the vHub interface; and (ii) write the returned data and metadata to a data store in the Big Data platform. The vHub interface communicates with the vConnect interfaces 104, 105, 106, 107 associated with the data management systems to facilitate the transfer and conversion of the data.

The Big Data platform(s) communicate with the first partition 120 through a network interface 115, or alternatively, through a system memory bus 116. Both modes of communication provide high-speed connectivity between the partitions. In one example, a user 180 interacts with a graphical user interface (“GUI”) to access the vHub interface 152a in Big Data application 150a in order to select data and metadata from one of the legacy data management resources to be transferred to a data store in the Big Data platform.

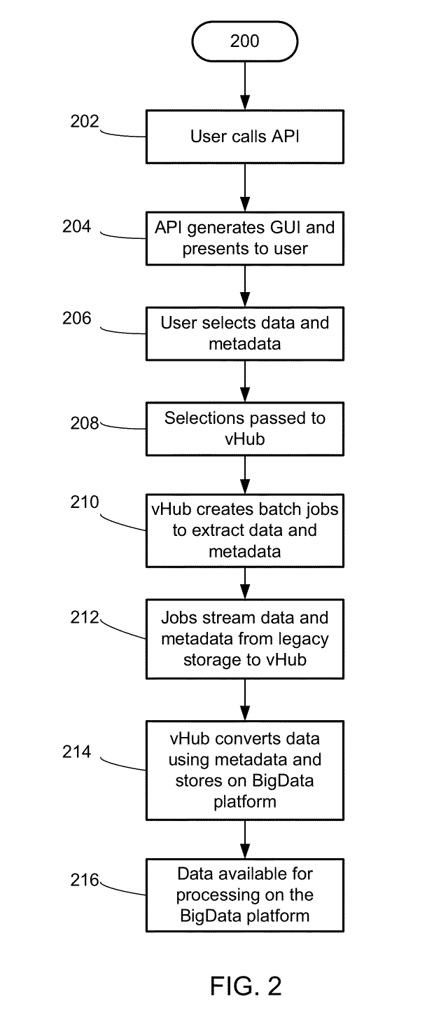

FIG. 2 illustrates a process 200 for identifying and extracting data from a legacy data source in the first partition LPAR 120 of the mainframe 100, and transferring the data into a large data set, such as platform 150a, configured in the second partition LPAR 130 on the mainframe.

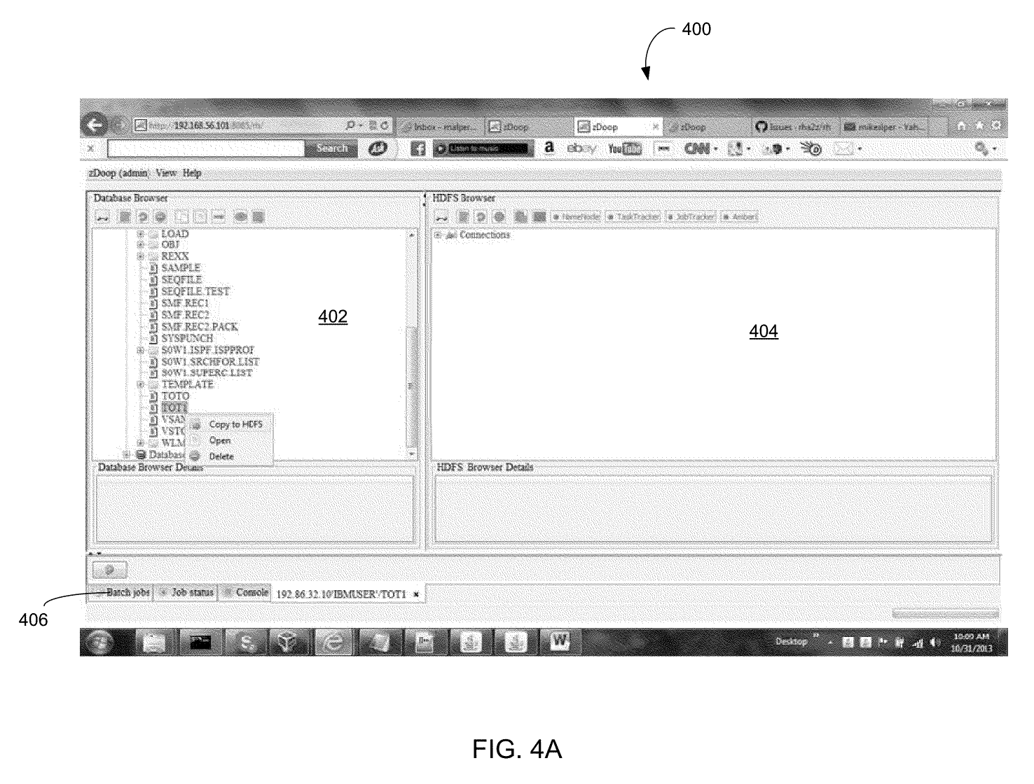

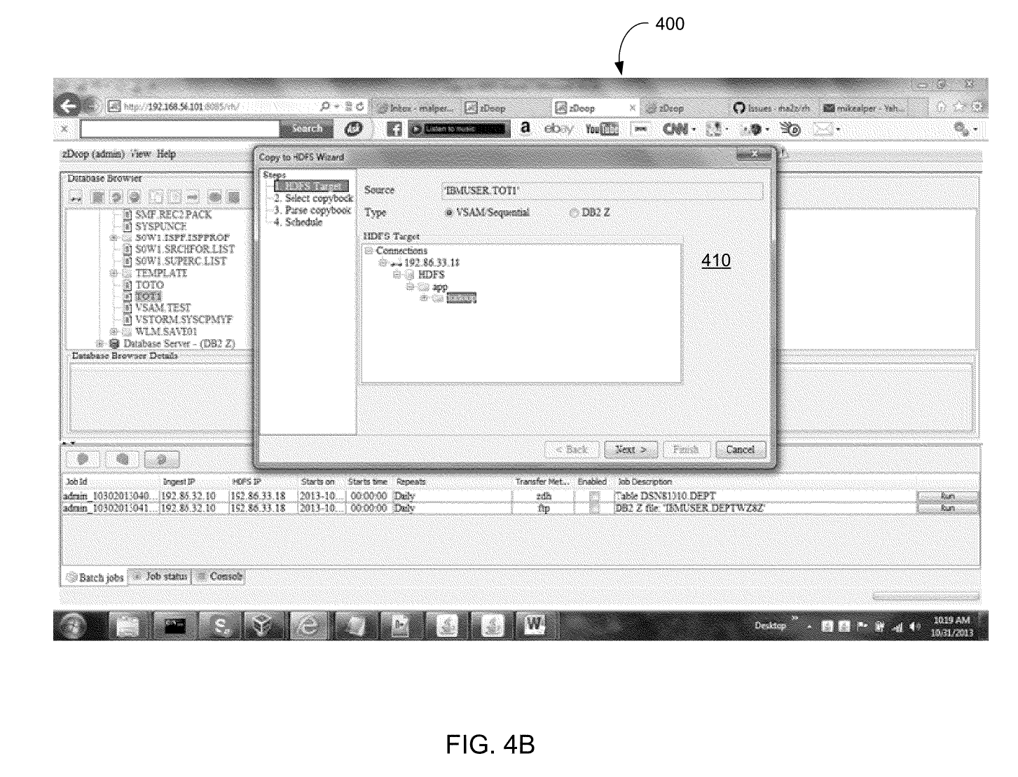

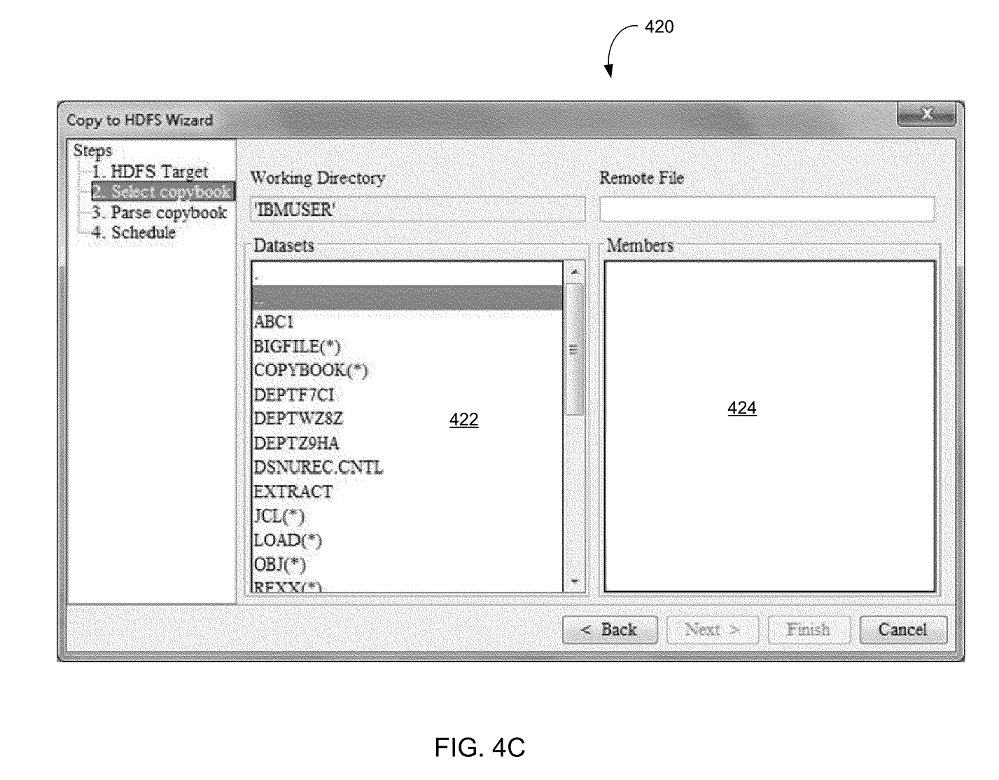

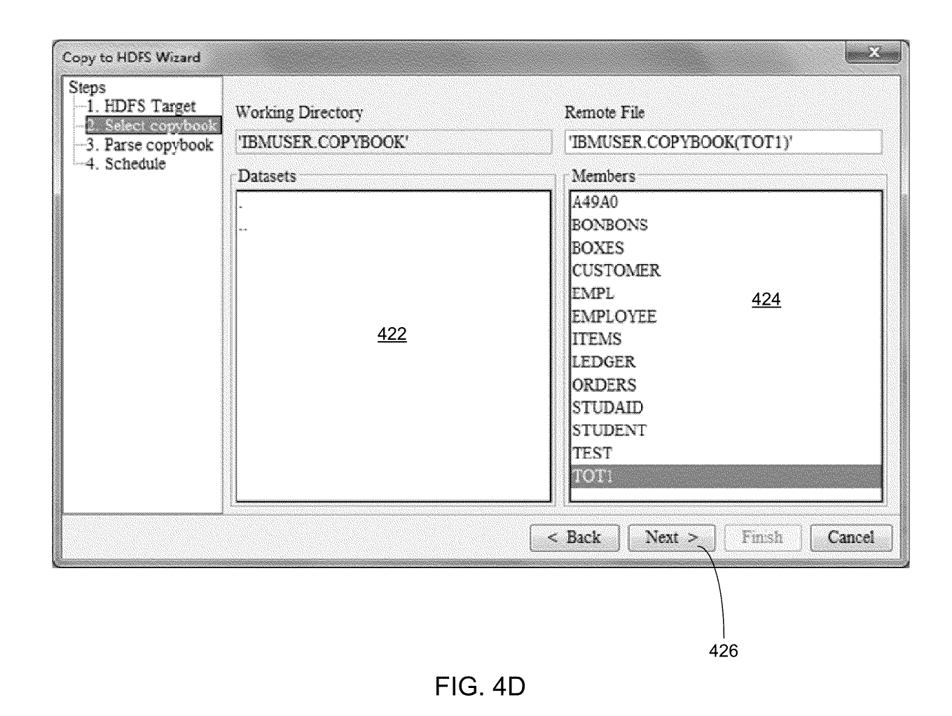

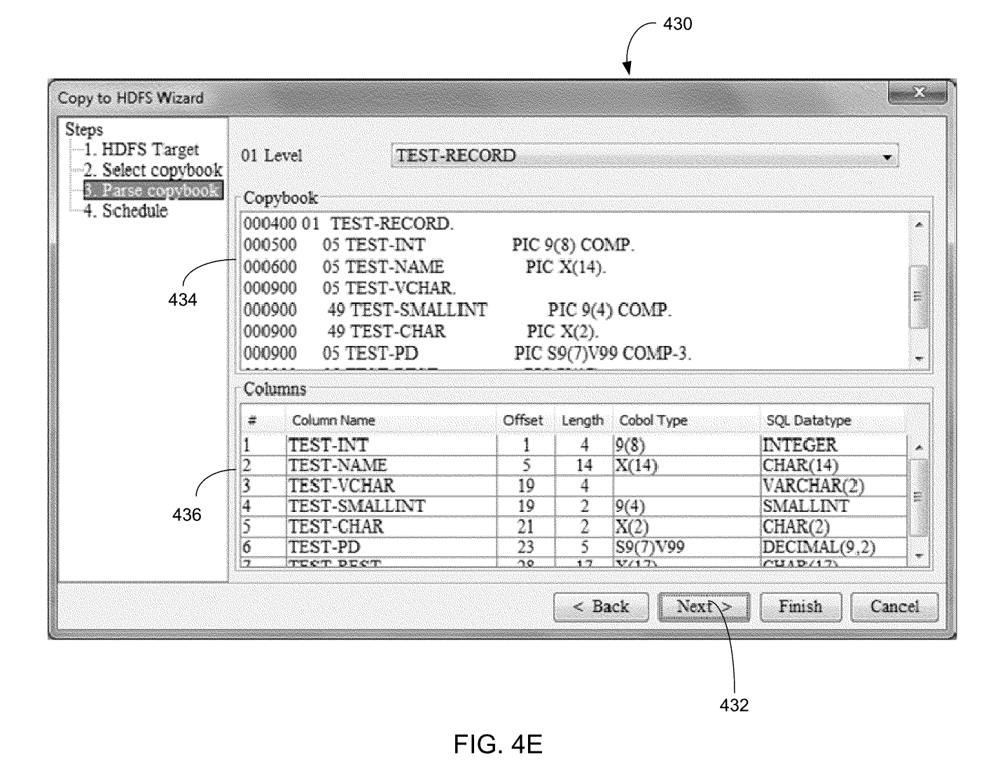

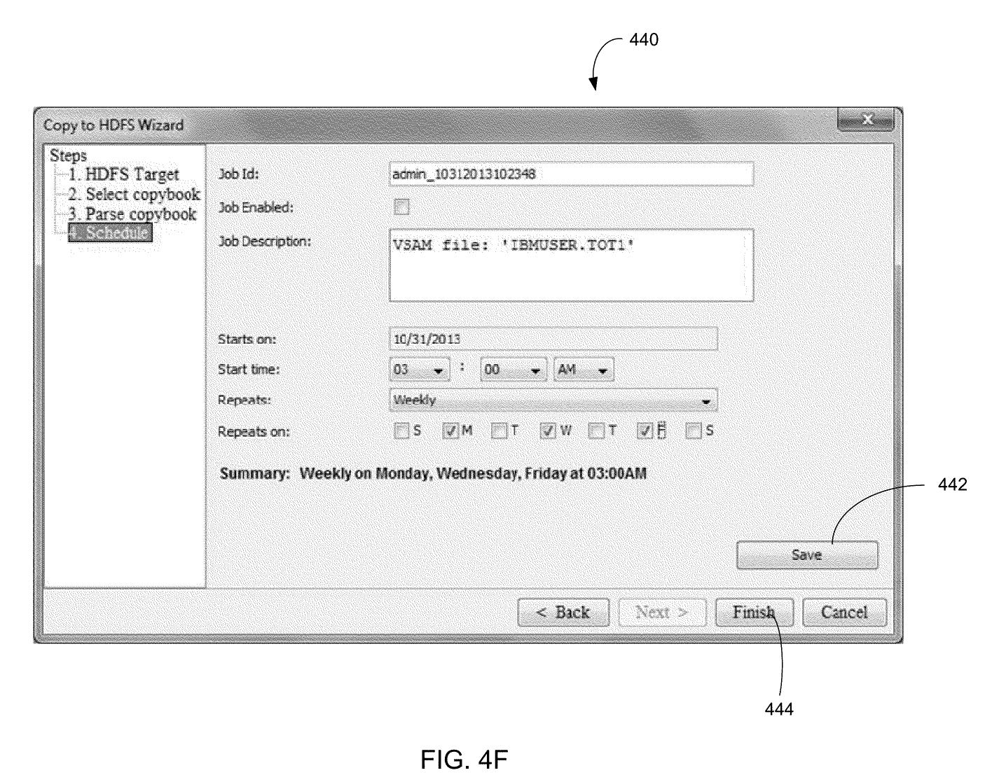

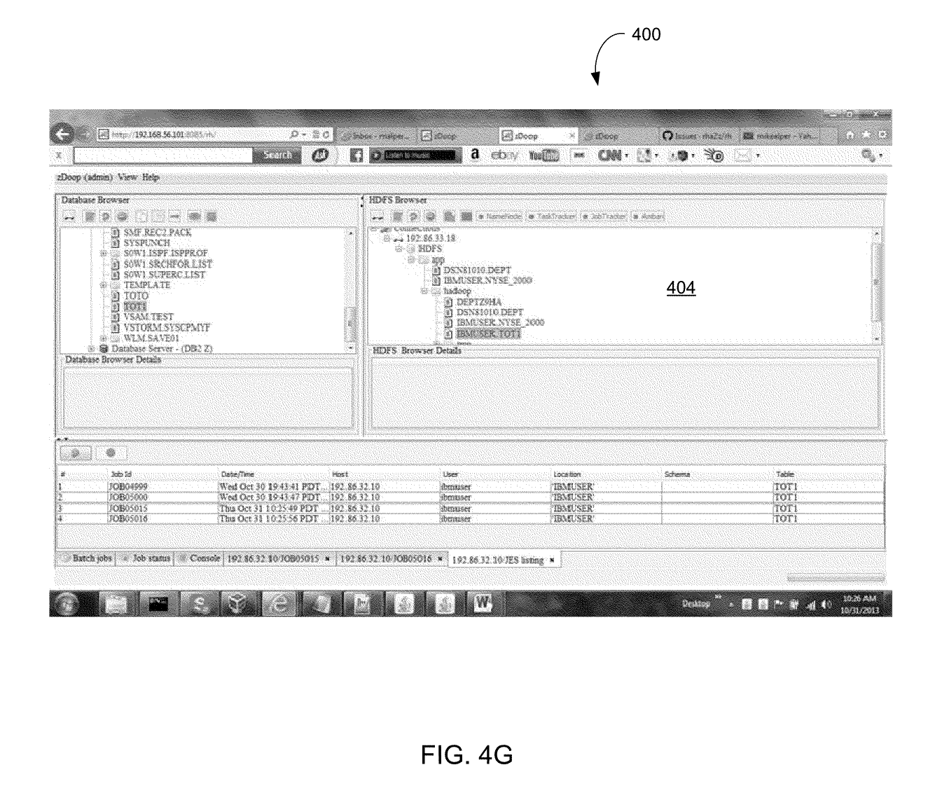

In step 202, the user 180 calls a RESTful API to explore, discover data and metadata artifacts stored in one or more of the legacy databases 121, 122, 123 or 124. In step 204, the API generates data that is presented to the user via graphical user interface (“GUI”) 181 and presents it to the user 180. The GUI 181 is configured to present choices to the user 180, and upon the user making a selection, another screen will be presented to the user. In step 206, the user 180 selects data and corresponding metadata to transfer from the selected legacy system to a selected Big Data platform. Examples of the GUI screens are illustrated in FIG. 4A-4K, described below.

In step 208, the GUI 181 passes the user selections to the vHub interface 152a. In step 210, the vHub interface creates JCL processes to extract the identified data from the selected legacy system using the lowest level APIs specific to the type of legacy database. Using the lowest level APIs provides better performance and reduced charges for mainframe usage. In step 212, the JCL processes stream the metadata and the data in binary format via either the network interfaces or the memory bus (hipersocket) to the vHub interface. In step 214, the vHub interface converts the binary data to the format of the Big Data target, using the metadata, then stores the data and metadata directly on the Big Data target using an API of the Big Data platform.

Finally, in step 216, the metadata and the data is available to processing programs on the Big Data target.

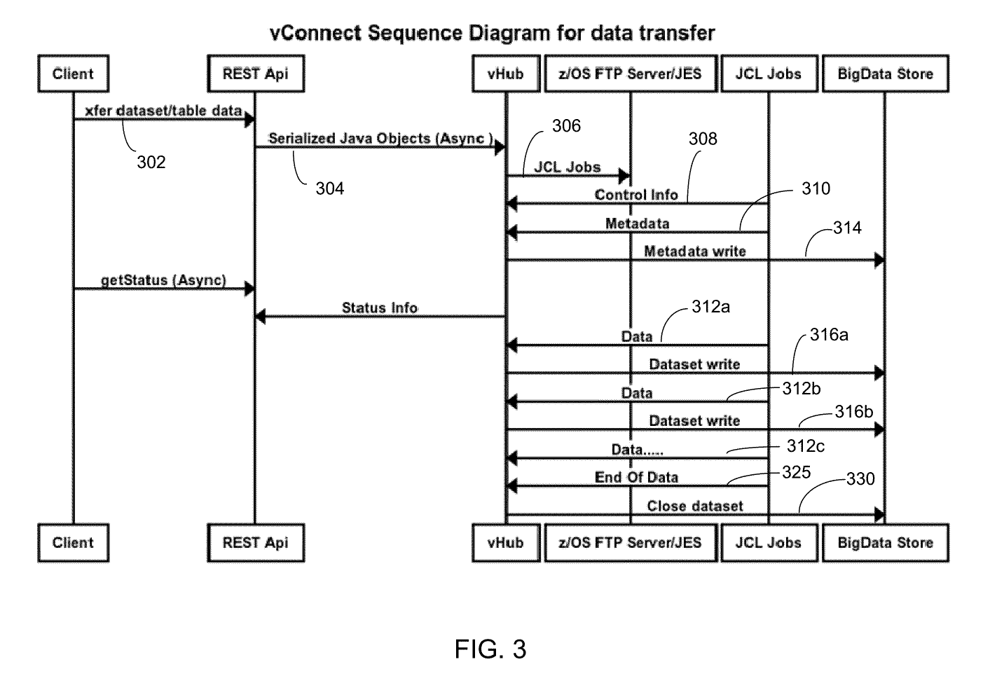

FIG. 3 depicts the process 200 from the perspective of data flow between the various components of the system 100. In step 302, the user program or client issues a RESTful API call to transfer data, in which the user identifies or selects the source dataset and the target. In step 304, the API pushes a serialized object to the vHub interface on the target Big Data virtual machine platform, describing the task. The vHub interface creates jobs that are sent to the z/OS server (step 306) and run to extract the specified data and send it back to the vHub interface. The jobs thus return control data (step 308), metadata (step 310) and then several blocks of data (312a, 312b, 312c, etc.) that flow from the jobs to the vHub interface. The vHub interface writes the metadata to the Big Data store (step 314) and then writes the blocks of data to the Big Data store (steps 316a, 316b, etc.). An end of data message from the job to the vHub interface (step 325) results in the vHub interface closing the dataset (step 330).

For maximum efficiency, the vHub interface transfers data from the mainframe in binary format or delimited text format, conversions are performed on the binary data, and records as a whole are converted to the target Big Data format. For example, in the Hadoop embodiment, for the HDFS target, the data is converted into a comma separated file format. The conversion process takes into account data type conversion from mainframe binary data types to Java data types and then to delimited text.

The vConnect interface software on the mainframe connects to the vHub interface software on the Linux platform and passes control information and metadata in standard EBCDIC format. The presentation layer is EBCDIC and is BIGENDIAN. Floating point data stored in a legacy data management system on the mainframe 100 are in either IBM s390 format or IEEE format. A typical mainframe supports zoned decimal and packed decimal formats that are converted to strings by the vHub interface software. For example, a binary record is converted into a text record where the columns are separated by a column separator.

In more detail, the vHub interface for receiving and converting data includes a Main thread (MainThread) that listens on a network endpoint. Upon receiving a connection request, the Main thread creates a network handler thread (NetworkHandlerThread) that receives the data and stages the data into memory. If data stored in the memory in the heap for the process reaches a threshold limit, the receiver thread throttles the sender. Another thread (ProcessDataThread) is spawned by the receiver thread and is responsible for extracting and converting the data. The Process data thread selects a record and, using the metadata, converts the binary data into a text format.

Referring now to FIGS. 4A-4G, a series of GUIs is illustrated by screenshots that may be presented as a “wizard” to guide the user in selecting and transferring data and metadata from a legacy system to a Big Data platform. In FIG. 4A, an initial display screen 400 is an explorer-type browser including a first window 402 on the left of the screen that is used to browse and select a file, in this example “TOT1”, and a second window 404 on the right of the screen that shows the contents of the file system on the Big Data platform.

Upon selecting one or more files to transfer in the first window 402, the wizard presents a first pop-up window 410 or new page, and the command “HDFS Target” is selected in order to identify the target Big Data platform, as shown in FIG. 4B. In this example, the previously selected path is highlighted, namely/app/hadoop.

Once the target path is identified, the wizard presents a second pop-up window 420 or new page as shown in FIG. 4C. The second page 420 includes a first window that shows a list 422 of datasets stored in the legacy system, and a second window 424 that shows the contents of the dataset. In an example with VSAM/sequential data, the dataset “COPYBOOK(*)” is selected, then the next button 426 is clicked. This lists the contents of the partitioned data set, COPYBOOK, in this case. The applicable COBOL copybook TOT1 can now be selected as shown in FIG. 4D.

Once the copybook has been selected as shown in FIG. 4D, the next button 426 is again selected. The wizard then presents a third pop-up window 430 with the contents after parsing the selected copybook as shown in 434 and 436. For example, each column is listed with a column number, column name, offset, length, COBOL type, and SQL data type.

Upon clicking the next button 432, the optional step “SCHEDULE” is selected, and the wizard presents a fourth pop-up window 440 or page as shown in FIG. 4F. Within window 440, the job to transfer and convert the selected data to the Big Data file system may be scheduled and saved by clicking the “SAVE” button 442 then the “FINISH” button 444. The job can be executed manually as well. A saved job can be viewed, modified and run by selecting the “batch jobs” tab 406 of the initial window 400. Once the job has been executed, the selected file appears in the browser tree 404 of the initial window 400, as shown in FIG. 4G.

Thus, the system and methods described can reduce the compute cost for mainframe processing by securely offloading, data conversion and manipulation on the virtual machine subsystem.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

1. A system, comprising:
a mainframe computer having a mainframe operating system and a virtual machine operating system installed thereon, and at least one legacy data management system accessible to the mainframe computer for storing data and metadata;
a plurality of virtual machine nodes configured through the virtual machine operating system;
a communication interface coupled between the legacy data management system and the plurality of virtual machine nodes;
a plurality of data processing nodes, each data processing node operating on a respective virtual machine node to thereby form a big data platform for storing and managing a plurality of datasets, each data processing node having a file manager and a virtual machine interface, the virtual machine interface in communication with a job control module configured on the mainframe operating system, wherein the virtual machine interface interacts with the job control module to facilitate movement of data and metadata from the legacy data management system to the big data platform; and
a graphical user interface configured for selecting data and metadata from the legacy data management system, identifying one or more target datasets, and transferring and converting the selected data to the target datasets using the metadata.

2. The system of claim 1, further comprising:
a plurality of legacy data management systems accessible to the mainframe computer and configured for storing data and metadata therein; and
a plurality of communication interfaces between mainframe operating system and the virtual machines forming the big data platform.

3. The system of claim 1, further comprising:
at least one dedicated processor on the mainframe computer configured to support the big data platform.

4. The system of claim 2, further comprising:
a plurality of dedicated processors on the mainframe computer, each dedicated processor configured to support a respective data processing node.

5. The system of claim 1, wherein an application programming interface presents the returned data to a user in the graphical user interface.

6. A method, comprising:
selecting data and metadata stored on a legacy data management system accessible to a mainframe operating system installed on a mainframe computer;
transferring the data and metadata to a big data platform running as a plurality of virtual machines configured on the mainframe computer;
converting the data to a format of the big data platform using the metadata.

7. The method of claim 6, further comprising:
providing a first communication interface coupled between the legacy data management system and the plurality of virtual machines; and
providing at least one second communication interface between the mainframe computer and the plurality of virtual machines, the second communication interface configured to send instructions to create batch jobs to extract the selected data and metadata from the legacy data management system and return the data and metadata via the first communication interface to the virtual machine, and to write the returned data and metadata to the big data platform.

8. The method of claim 7, further comprising:
presenting a graphical user interface to a user, the graphical user interface configured (i) to interact with the second communication interface to create the instructions for batch jobs to extract the selected data and metadata from the legacy data management system, (ii) to return the data and metadata via the first communication interface to the virtual machine and to write the returned data and metadata to the large dataset platform.

9. The method of claim 1, wherein the virtual machine interface is configured to (i) send instructions to the job control module to create batch jobs for extracting identified data and metadata from the legacy data management system, (ii) return the data and metadata via the first communication interface to the virtual machine interface, and (iii) write the returned data and metadata to the datasets in the big data platform.

10. A non-transitory machine readable medium encoded with executable instructions which, when executed by a processor, cause the process or carry out the steps of:
selecting data and metadata stored on a legacy data management system accessible to a mainframe computer;
transferring the data and metadata to a big data platform running as a plurality of virtual machines configured on the mainframe computer;
converting the data to a format of the big data platform using the metadata.

11. The machine readable medium of claim 10, further comprising:
providing a first communication interface coupled between the legacy data management system and the plurality of virtual machines; and
providing at least one second communication interface between the mainframe computer and the plurality of virtual machines, the second communication interface configured to send instructions to create batch jobs to extract the selected data and metadata from the legacy data management system and return the data and metadata via the communication interface to the virtual machine, and to write the returned data and metadata to the big data platform.

12. The machine readable medium of claim 11, further comprising:
presenting a graphical user interface to a user, the graphical user interface configured to interact with the second communication interface to create the instructions for batch jobs to extract the selected data and metadata from the legacy data management system and return the data and metadata via the first communication interface to the virtual machine which then writes the returned data and metadata to the big data platform.
